(19) United States
(12) Patent Application Publication
(10) Pub. No.: US 2015/0364073 A1
(43) Pub. Date: Dec. 17, 2015

(54) PORTABLE TERMINAL AND PORTABLE TERMINAL CONTROL METHOD

(71) Applicant: KYOCERA Corporation, Kyoto-shi (JP)

(72) Inventor: Shinya OGAWA, Osaka (JP)

(73) Assignee: KYOCERA Corporation

(21) Appl. No.: 14/832,923

(22) Filed: Aug. 21, 2015

Related U.S. Application Data
(63) Continuation of application No. PCT/JP2014/054193, filed on Feb. 21, 2014.

(30) Foreign Application Priority Data
Feb. 22, 2013 (JP) 2013-033079

(51) Int. Cl. G09G 3/20; G06F 3/0485; G06F 3/041

(52) U.S. Cl. CPC G09G 3/2003; G06F 3/041; G06F 3/0485; G09G 2320/0626

(57) ABSTRACT

A portable terminal includes a display, a display processing module that can perform display processing of causing the display to display an image such that an image in a scroll target area which is at least a portion of an image display area on the display is scrolled, a calculation module that can perform calculation processing of calculating a scroll speed of the image in the scroll target area, and a brightness adjustment module that can adjust a brightness of an image displayed on the display such that, with respect to the brightness of an image displayed on the display when the scroll speed calculated by the calculation module is a first speed, the brightness of an image displayed on the display when the scroll speed calculated by the calculation module is a second speed becomes darker, the second speed being faster than the first speed.

### CROSS-REFERENCE TO RELATED APPLICATION

The present application is a bypass continuation of international application PCT Application No. PCT/JP2014/054193 filed on Feb. 21, 2014, entitled “Portable Terminal and Portable Terminal Control Method”, which claims the benefit of Japanese Application No. 2013-033079, filed on Feb. 22, 2013, entitled “Portable Terminal and Portable Terminal Control Method.” The disclosure of the above applications are each incorporated herein by reference.

### FIELD

The present disclosure relates to a technique for a portable terminal provided with a display.

### BACKGROUND

Generally, a portable terminal performs processing using electric power stored in a built-in battery. Therefore, in order to extend its processable period, reduction in power consumption in the portable terminal is required.

Examples of a known technique for achieving reduction in power consumption in a portable terminal include a technique for reducing luminance of some pixels in an image displayed on a display and a technique for selecting an image that allows for reduced power consumption of a display as a background image on the display.

### SUMMARY

A portable terminal of an embodiment includes a display and a processor. The processor is configured to cause the display to display an image such that the image in a scroll target area which is at least a portion of an image display area on the display is scrolled, and calculate a scroll speed of the image in the scroll target area. The scroll speed includes a first speed and a second speed which is faster than the first speed. The processor is configured to cause the display to adjust a brightness of the image displayed on the display such that the brightness is darker when the scroll speed is the second speed than when the scroll speed is the first speed.

### BRIEF DESCRIPTION OF THE DRAWINGS

FIG. 1 is a perspective view of a portable terminal.

FIG. 2 is a block diagram showing a circuit arrangement of a portable terminal.

FIG. 3 is an exploded perspective view of a touch panel.

FIG. 4 is a functional block diagram of a scroll processing module.

FIG. 5 is a schematic view showing an example of an image generated by a first display processing module.

FIG. 6 is a schematic view showing an example of an image generated by a second display processing module.

FIG. 7 is a threshold speed table.

FIG. 8 is a flowchart of scroll processing.

FIG. 9 is a threshold speed table of a first variation.

FIG. 10 is a first flowchart of scroll processing of the first variation.

FIG. 11 is a second flowchart of scroll processing of the first variation.

FIG. 12 is an exploded perspective view of a touch panel of a second variation.

FIG. 13 is a first flowchart of scroll processing of the second variation.

FIG. 14 is a second flowchart of scroll processing of the second variation.

FIG. 15 is a third flowchart of scroll processing of the second variation.

### DETAILED DESCRIPTION

### Embodiment

### Outline

As an example of a portable terminal according to the present disclosure, a portable terminal provided with a touch panel including a liquid crystal display composed of a liquid crystal panel and a backlight will be described below.

Generally, when it is predicted that a relatively long time will be necessary until a display target to be displayed appears on the display during an image scroll period, a user using a portable terminal is likely to scroll an image relatively quickly wile hardly gazing at the image being scrolled. On the other hand, when it is predicted that a relatively long time will not be necessary until a display target to be displayed appears on the display, a user is likely to scroll an image relatively slowly while relatively fixedly gazing at the image being scrolled.

Therefore, it can be said that relatively little discomfort is given to a user if the brightness of an image during a period in which the image is being scrolled relatively quickly and in which a user is less likely to gaze at the image being scrolled is made darker than the brightness of an image during a period in which the image is being scrolled relatively slowly and in which a user is likely to gaze at the image being scrolled.

A portable terminal according to an embodiment is a so-called smartphone-type portable communication terminal, which is driven with a built-in battery, and in the case where an image including a scroll area is displayed on a touch panel, the light amount of a backlight is decreased when the scroll speed of the scroll area becomes more than or equal to a predetermined speed. Accordingly, reduction of power consumption can be achieved while making discomfort given to a user relatively small.

Hereinafter, the details of this portable terminal will be described with reference to the drawings.

<Configuration>

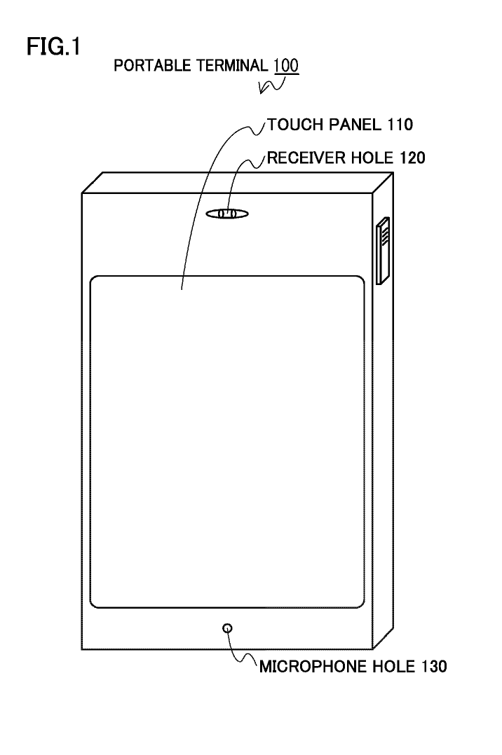

FIG. 1 is a perspective view showing the appearance of a portable terminal 100.

As shown in the drawing, portable terminal 100 is a so-called smartphone-type portable communication terminal provided with a generally rectangular parallelepiped enclosure, and includes a touch panel 110, a receiver hole 120 and a microphone hole 130 on a main surface of the enclosure.

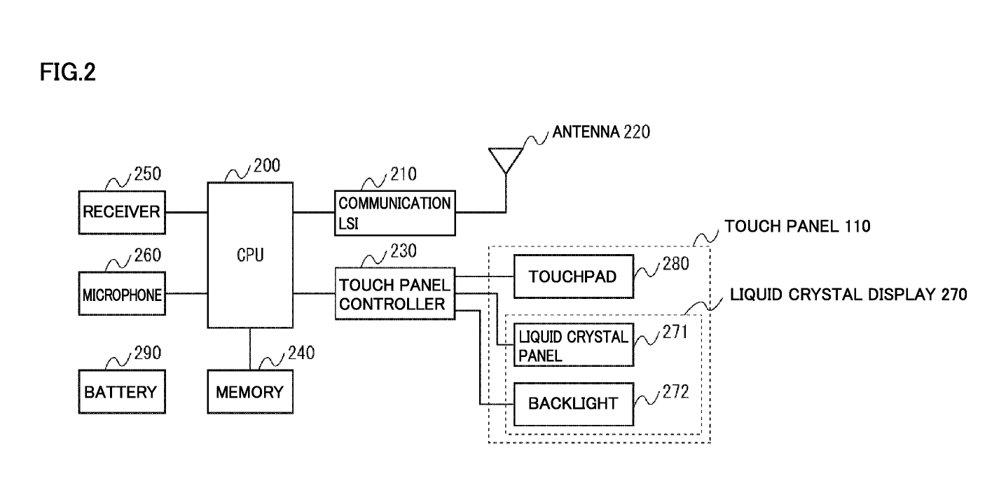

FIG. 2 is a block diagram showing a circuit arrangement of portable terminal 100.

As shown in the drawing, portable terminal 100 can include a CPU (Central Processing Unit) 200, a communication LSI (Large Scale Integration) 210, an antenna 220, a touch panel controller 230, touch panel 110, a memory 240, a receiver 250, a microphone 260, and a battery 290. Touch panel 110 can include a liquid crystal display 270 composed of a liquid crystal panel 271 and a backlight 272, as well as a touchpad 280.

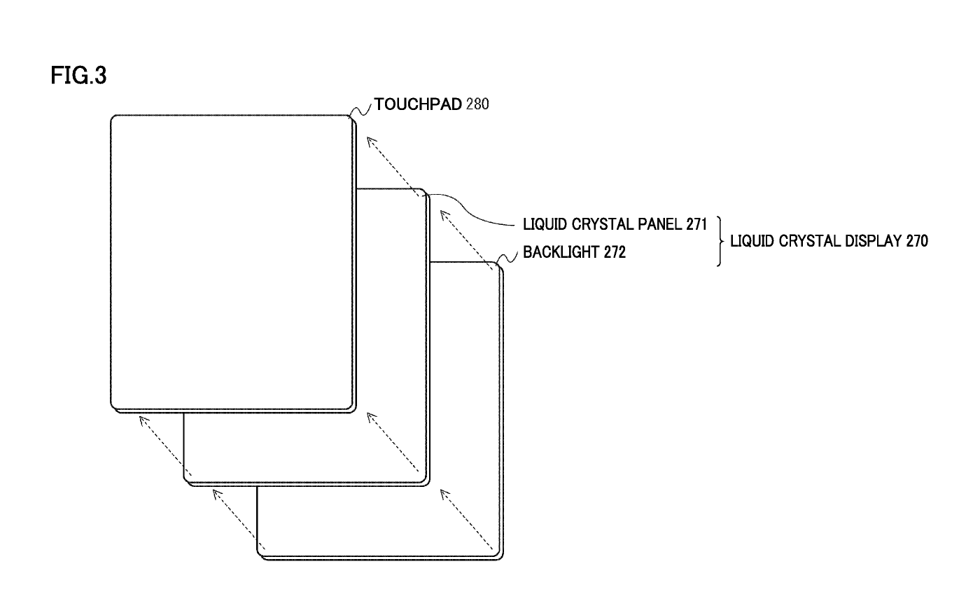

FIG. 3 is an exploded perspective view of touch panel 110.

As shown in the drawing, touch panel 110 can be formed by arranging transparent touchpad 280 over the display surface of liquid crystal display 270. Furthermore, liquid crystal display 270 can be formed by arranging backlight 272 over the rear surface of liquid crystal panel 271.

Returning to FIG. 2, description of the circuit arrangement of portable terminal 100 will be continued.

Receiver 250 is connected to CPU 200, is controlled by CPU 200, and has a function that can convert an electrical signal received from CPU 200 into sound and can output the converted sound to the outside of the enclosure through receiver hole 120 (see FIG. 1).

Microphone 260 is connected to CPU 200, and has a function that can convert sound received from the outside of the enclosure through microphone hole 130 (see FIG. 1) into an electrical signal and can send the converted electrical signal to CPU 200.

Antenna 220 is, for example, a metal monopole antenna that is connected to communication LSI 210 and is used in communications made by communication LSI 210.

Communication LSI 210 is connected to antenna 220 and CPU 200, is controlled by CPU 200, and has a modulation function that can modulate a signal for transmission received from CPU 200, a transmission function that can transmit the modulated signal to an external base station using antenna 220, a receiving function that can receive a signal transmitted from the external base station using antenna 220, and a demodulation function that can demodulate the received signal for transmission to CPU 200.

Liquid crystal panel 271 is a liquid crystal panel that can be connected to touch panel controller 230 and can be controlled by touch panel controller 230.

Backlight 272 is a backlight that can be connected to touch panel controller 230, and can be controlled in light amount by touch panel controller 230.

Touchpad 280 is a transparent touchpad, which is connected to touch panel controller 230, is controlled by touch panel controller 230, and has a transparent electrode (e.g., made of ITO (Indium Tin Oxide)).

Touch panel controller 230 is connected to CPU 200, liquid crystal panel 271, backlight 272, and touchpad 280, is controlled by CPU 200, and has a display function that can cause liquid crystal panel 271 to display an image based on an image signal received from CPU 200, a light amount control function that can turn on backlight 272 with a light amount based on a control signal received from CPU 200, and an operation receiving function that can convert a user's operation performed with touchpad 280 by a user using portable terminal 100 into an electrical signal for transmission to CPU 200.

Memory 240 is connected to CPU 200, includes a RAM (Random Access Memory), a ROM (Read Only Memory) and a removable flash memory, and stores a program that can specify operations of CPU 200 and data that can be used by CPU 200.

CPU 200 is connected to communication LSI 210, touch panel controller 230, memory 240, receiver 250, and microphone 260, and executes the program stored in memory 240 to control communication LSI 210, touch panel controller 230 and receiver 250, thereby achieving two functions which will be described below

Smartphone control function: this is a function of controlling portable terminal 100 to allow portable terminal 100 to achieve functions equivalent to general functions as a smartphone possessed by conventional smartphone, for example, a call function, an

Internet site browsing function, an e-mail reception/transmission function, a standby function, and the like. This smartphone control function can be implemented by CPU 200 executing the program stored in memory 240.

Scroll-time light-amount control function: this is a function that, when portable terminal 100 is controlled to allow portable terminal 100 to implement scroll processing which is a characteristic operation thereof, so that in the case where touch panel 110 is displaying an image including a scroll area, when the scroll speed of the scroll area becomes more than or equal to a predetermined speed, the light amount of backlight 272 can be decreased, and when the scroll speed of the scroll area falls below the predetermined speed again, the light amount of backlight 272 returns to the original light amount. This scroll time light amount control function can be implemented by CPU 200 executing the program stored in memory 240.

It should be noted that the scroll processing will be described later in detail in a section <Scroll Processing> with reference to a flowchart.

Battery 290 is a rechargeable battery which is rechargeable repeatedly, and has a function that can supply electric power to electronic components constituting portable terminal 100.

The configuration of portable terminal 100 having the above-described circuit arrangement in terms of its functions will be described below. Description will be focused on a scroll processing module which is a functional block that can implement scroll processing which is characteristic processing performed by portable terminal 100 among the functional blocks constituting portable terminal 100.

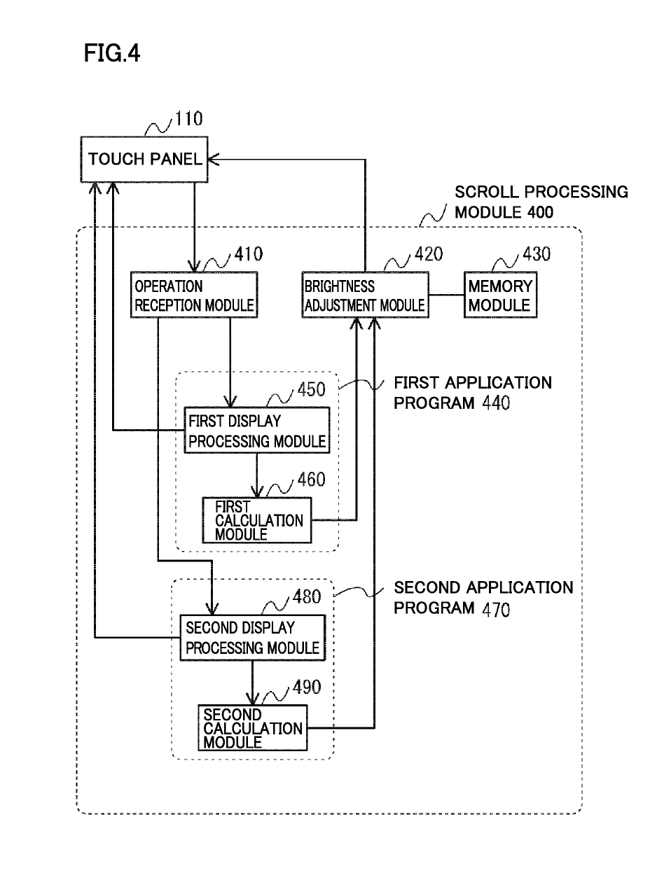

FIG. 4 is a block diagram showing main functional blocks constituting a scroll processing module 400. Description will be made by way of example on the case where a first application program 440 and a second application program can be executed in portable terminal 100.

As shown in the drawing, scroll processing module 400 includes an operation reception module 410, a brightness adjustment module 420, a memory module 430, a first display processing module 450, a first calculation module 460, a second display processing module 480, and a second calculation module 490. Among them, first display processing module 450 and first calculation module 460 can be implemented by CPU 200 executing first application program 440 stored in memory 240, and second display processing module 480 and second calculation module 490 can be implemented by CPU 200 executing a second application program 470 stored in memory 240.

Operation reception module 410 has functions that can operate in cooperation with touch panel 110, first display processing module 450 and second display processing module 480, can be implemented by CPU 200 that can execute a program and touch panel controller 230 controlled by that CPU 200, and can receive a contact operation to touch panel 110 made by a user using portable terminal 100.

First display processing module 450 has functions that can operate in cooperation with operation reception module 410, first calculation module 460 and touch panel 110, can be implemented by CPU 200 that can execute first application program 440 and touch panel controller 230 controlled by that CPU 200, and can successively generate images in response to the contact operation on first application program 440 received by operation reception module 410 to cause touch panel 110 to display the images successively. Here, first display processing module 450 can generate images successively at a frame rate of 60 frames/sec, for example.

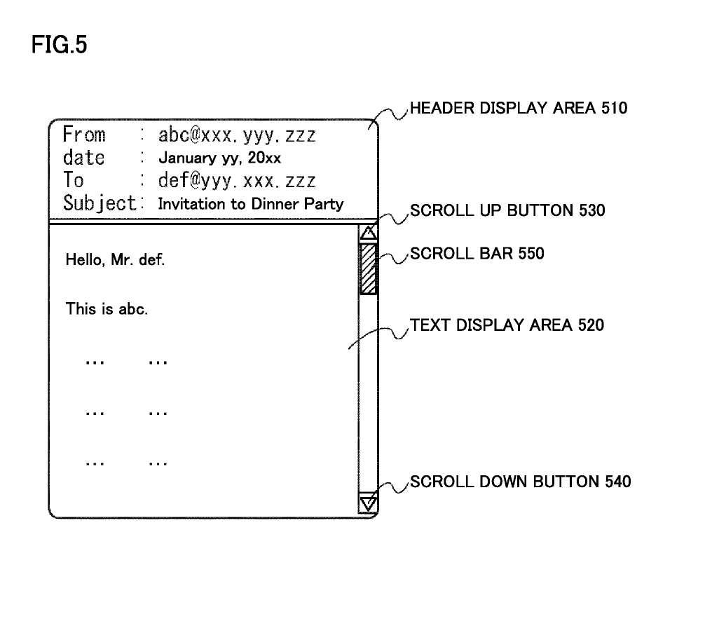

FIG. 5 is a schematic view showing an example of an image generated by first display processing module 450. Description will be made assuming that first application program 440 is a mailer having a function of causing touch panel 110 to display a received e-mail message selected by a user.

This drawing is an example of an image generated by first display processing module 450 (hereinafter referred to as a “first type image”) in the case where first application program 440 (mailer) causes touch panel 110 to display a received e-mail message selected by a user.

As shown in this drawing, the first type image includes a header display area 510, a text display area 520, a scroll up button 530, a scroll down button 540, and a scroll bar 550.

Header display area 510 is an area in which header information of a received e-mail message selected by a user is displayed.

Text display area 520 is an area in which text of a received e-mail message selected by a user is displayed. For example, a character string of ten lines of text is displayed on this text display area 520. In this text display area 520, an image displayed therein may be scrolled by the following three types of operations on touch panel 110 made by a user.

A first scroll button contact operation refers to a contact operation made by a user on scroll up button 530 or scroll down button 540 being displayed on touch panel 110.

Here, first display processing module 450 can generate first type images successively such that an image displayed on text display area 520 is scrolled upward by the same number of lines as the number of contacts on scroll up button 530, and such that an image is scrolled downward by the same number of lines as the number of contacts on scroll down button 540.

A first scroll bar sliding operation refers to a sliding operation made by a user on scroll bar 550 being displayed on touch panel 110.

Here, first display processing module 450 can generate first type images successively such that an image displayed on text display area 520 is scrolled at a scroll speed which is proportional to the sliding speed of scroll bar 550.

Here, the sliding speed refers to the number of slid dots of the scroll bar per unit time, and the scroll speed refers to the number of displaced dots at a display position of a display target between a current frame and a previous frame. For example, the scroll speed in the case where a display target is displaced by 10 dots from the previous frame to the current frame will be 10 dots/frame.

A first flicking operation refers to a flicking operation made by a user on text display area 520 displayed on touch panel 110.

Here, first display processing module 450 can generate first type images successively such that, for an image displayed in text display area 520, the scroll speed at the start of scrolling assumes a speed proportional to a flicking speed in a flicking operation, and then the scroll speed decreases gradually.

Here, the flicking speed refers to a moving distance of a finger or the like per unit time in a flicking operation.

Returning to FIG. 4, description of scroll processing module 400 will be continued.

First calculation module 460 has a function that can operate in cooperation with first display processing module 450 and brightness adjustment module 420, can be implemented by CPU 200 that can execute first application program 440, and can calculate the scroll speed in text display area 520 based on a predetermined algorithm defined by first application program 440 each time first display processing module 450 generates an image and can transmit the calculated scroll speed to brightness adjustment module 420.

Second display processing module 480 has a function that can operate in cooperation with operation reception module 410, second calculation module 490 and touch panel 110, can be implemented by CPU 200 that can execute second application program 470 and touch panel controller 230 controlled by that CPU 200, and can generate images successively in accordance with a contact operation on second application program 470 received by operation reception module 410 for successive display on touch panel 110. Here, second display processing module 480 can generate images successively at a frame rate of 60 frames/sec, for example, similarly to first display processing module 450.

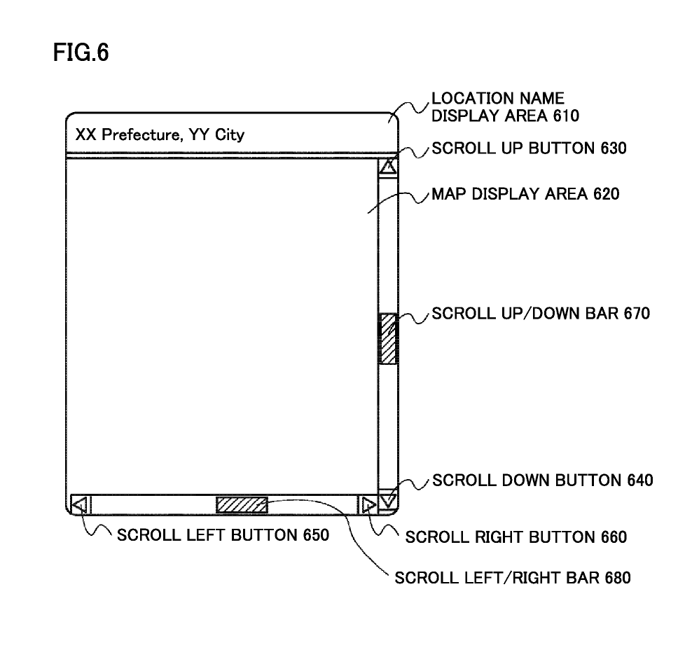

FIG. 6 is a schematic view showing an example of an image generated by second display processing module 480. Description will be made assuming that second application program 470 is a map display application having a function that can cause touch panel 110 to display a map of a region designated by a user.

This drawing is an example of an image generated by second display processing module 480 (hereinafter referred to as a “second type image”), in the case where second application program 470 (map display application) causes touch panel 110 to display a map of a region designated by a user.

As shown in the drawing, the second type image includes a location name display area 610, a map display area 620, a scroll up button 630, a scroll down button 640, a scroll left button 650, a scroll right button 660, a scroll up/down bar 670, and a scroll left/right bar 680.

Location name display area 610 is an area in which the name of a place indicating a region in a map displayed on map display area 620 is displayed.

Map display area 620 is an area in which a map of a region designated by a user is displayed. In this map display area 620, an image displayed therein may be scrolled by the following three types of operations on touch panel 110 made by a user.

A second scroll button contact operation refers to a contact operation made by a user on scroll up button 630, scroll down button 640, scroll left button 650, or scroll right button 660 displayed on touch panel 110.

Here, second display processing module 480 can generate second type images successively such that an image displayed on map display area 620 is scrolled upward by a displacement amount proportional to the number of contacts on scroll up button 630, scrolled downward by a displacement amount proportional to the number of contacts on scroll down button 640, scrolled leftward by a displacement amount proportional to the number of contacts on scroll left button 650, and scrolled rightward by a displacement amount proportional to the number of contacts on scroll right button 660.

A second scroll bar sliding operation refers to a sliding operation made by a user on scroll up/down bar 670 or scroll left/right bar 680 displayed on touch panel 110.

Here, second display processing module 480 can generate second type images successively such that an image displayed in map display area 620 is scrolled upward/downward at a scroll speed proportional to the sliding speed of scroll up/down bar 670, and is scrolled leftward/rightward at a scroll speed proportional to the sliding speed of scroll left/right bar 680.

A second flicking operation refers to a flicking operation made by a user on map display area 620 displayed on touch panel 110.

Here, second display processing module 480 can generate second type images successively such that, for an image displayed in map display area 620, the scroll speed at the start of scrolling assumes a speed proportional to a flicking speed in a flicking operation, and then the scroll speed decreases gradually.

Returning to FIG. 4, description of scroll processing module 400 will be continued.

Second calculation module 490 can operate in cooperation with second display processing module 480 and brightness adjustment module 420, can be implemented by CPU 200 that can execute second application program 470, and has a function that can calculate the scroll speed in map display area 620 based on a predetermined algorithm defined by second application program 470 each time second display processing module 480 generates an image and each time first display processing module 450 generates an image and can transmit the calculated scroll speed to brightness adjustment module 420.

Memory module 430 can be implemented by CPU 200 executing a program and a storage area of memory 240, and has a function that can store a threshold speed table 700.

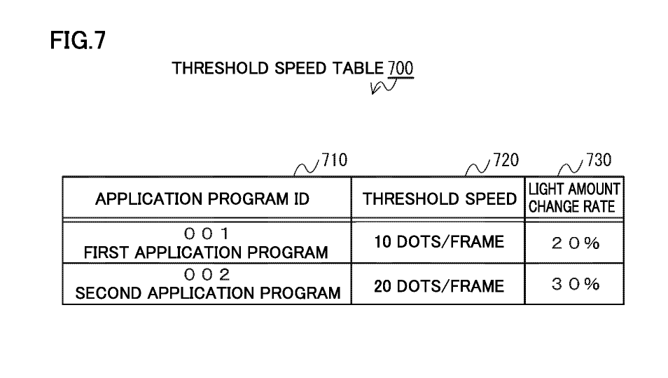

FIG. 7 is threshold speed table 700 stored in memory module 430.

As shown in this drawing, an application program ID 710, a threshold speed 720 and a light amount change rate 730 associated with one another constitute threshold speed table 700.

Application program ID 710 is an identifier for identifying an application program having a function of scrolling an image.

Assuming that at least part of an image displayed on touch panel 110 is scrolled in a situation where an application program identified by corresponding application program ID 710 is executed by CPU 200, and assuming that the light amount of backlight 272 is changed between when the scroll speed is a first speed and when the scroll speed is a second speed faster than the first speed, threshold speed 720 is a scroll speed for distinguishing between the first speed and the second speed, and is a threshold value between the first speed and the second speed. Assuming that at least part of an image displayed on touch panel 110 is scrolled in a situation where an application program identified by corresponding application program ID 710 is executed by CPU 200, and assuming that the light amount of backlight 272 is changed between when the scroll speed of that image is a first speed and when the scroll speed is a second speed faster than the first speed, light amount change rate 730 is a light decrease rate of the light amount of backlight 272 when the scroll speed is the second speed relative to the light amount of backlight 272 when the scroll speed is the first speed (a ratio of light volume difference relative to the light amount before light decreasing).

Returning to FIG. 4, description of scroll processing module 400 will be continued.

Brightness adjustment module 420 can operate in cooperation with touch panel 110, memory module 430, first calculation module 460, and second calculation module 490, can be implemented by CPU 200 executing a program and touch panel controller 230 controlled by that CPU 200, and has six functions as described below.

A first determining function is a function that, when a scroll speed is received from first calculation module 460 in the case where CPU 200 executes first application program 440, can determine whether or not that scroll speed is more than or equal to threshold speed 720 corresponding to application program ID 710 that identifies first application program 440 with reference to threshold speed table 700 stored in memory module 430 (this determination will hereinafter be referred to as a “first determination”).

A first light decreasing function is a function that, in the case where the first determination made by CPU 200 changes from a negative determination to an affirmative determination, (1) can store the light amount of backlight 272 at the time of change from the negative determination to the affirmative determination, and (2) with reference to threshold speed table 700 stored in memory module 430, can change the light amount of backlight 272 to a light amount obtained by decreasing the stored light amount by the light decrease rate indicated by light amount change rate 730 corresponding to application program ID 710 that identifies first application program 440.

Here, the light amount can be changed by causing touch panel controller 230 to control the light amount of backlight 272.

A first brightening function is a function that, in the case where the first determination made by CPU 200 changes from the affirmative determination to the negative determination, can change the light amount of backlight 272 to a light amount stored finally.

A second determining function is a function that, when a scroll speed is received from second calculation module 490 in the case where CPU 200 is executing second application program 470, can determine whether or not that scroll speed is more than or equal to threshold speed 720 corresponding to application program ID 710 that identifies second application program 470, with reference to threshold speed table 700 stored in memory module 430 (this determination will hereinafter be referred to as a “second determination”).

A second light decreasing function is a function that, in the case where the second determination made by CPU 200 changes from the negative determination to the affirmative determination, (1) can store the light amount of backlight 272 at the time of change from the negative determination to the affirmative determination, and (2) with reference to threshold speed table 700 stored in memory module 430, can change the light amount of backlight 272 from the stored light amount to a light amount decreased by the light decrease rate indicated by light amount change rate 730 corresponding to application program ID 710 that identifies second application program 470.

A second brightening function is a function that, in the case where the second determination made by CPU 200 changes from the affirmative determination to the negative determination, can change the light amount of backlight 272 to a light amount stored finally.

Operations performed by portable terminal 100 having the above-described configuration will be described below with reference to the drawings.

<Operation>

Scroll processing which is a characteristic operation among the operations performed by portable terminal 100 will be described.

<Scroll Processing>

In the case where at least a part of an image displayed on touch panel 110 is being scrolled, scroll processing is processing that (1) can decrease the light amount of backlight 272 when the scroll speed of the scroll area becomes more than or equal to a threshold speed, and (2) can return the light amount of backlight 272 to the original light amount when the scroll speed of the scroll area becomes less than the threshold speed again.

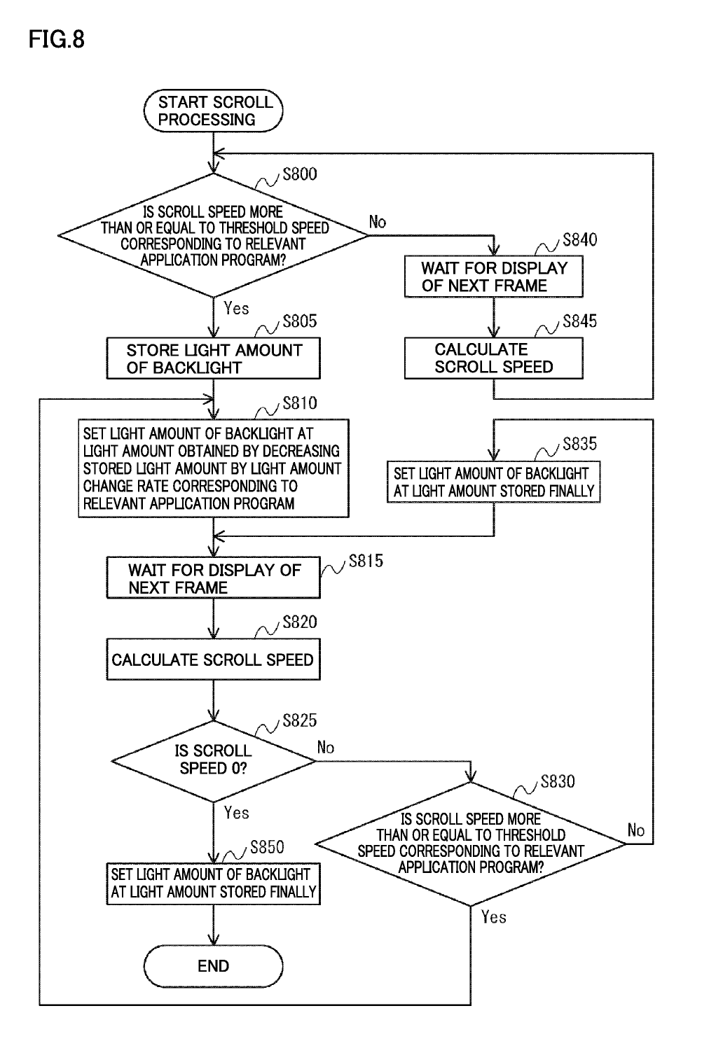

FIG. 8 is a flowchart of scroll processing.

The scroll processing can be started when first calculation module 460 has calculated a scroll speed other than 0 or when second calculation module 490 has calculated a scroll speed other than 0. The scroll processing can be started when an image of text display area 520 starts scrolling in the case where a first type image (see FIG. 5) is displayed on touch panel 110, or when an image of map display area 620 starts scrolling in the case where a second type image (see FIG. 6) is displayed on touch panel 110.

When the scroll processing is started, brightness adjustment module 420 can check whether or not the calculated scroll speed is more than or equal to threshold speed 720 corresponding to a relevant application program, with reference to threshold speed table 700 stored in memory module 430 (step S800). When a scroll speed other than 0 is received from first calculation module 460, brightness adjustment module 420 can check whether or not the scroll speed is more than or equal to threshold speed 720 (more than or equal to 10 dots/frame) corresponding to application program ID 710 that identifies first application program 440, with reference to threshold speed table 700 stored in memory module 430. When a scroll speed other than 0 is received from second calculation module 490, brightness adjustment module 420 can check whether or not the scroll speed is more than or equal to threshold speed 720 (more than or equal to 20 dots/frame) corresponding to application program ID 710 that identifies second application program 470, with reference to threshold speed table 700 stored in memory module 430.

In the operation of step S800, in the case where the calculated scroll speed is more than or equal to the threshold speed corresponding to the relevant application program (Yes in step S800), brightness adjustment module 420 stores the light amount of backlight 272 at present (step S805).

With reference to threshold speed table 700 stored in memory module 430, brightness adjustment module 420 can set the light amount of backlight 272 at a light amount obtained by decreasing the stored light amount by the light decrease rate indicated by light amount change rate 730 corresponding to the relevant application program (step S810). When a scroll speed other than 0 is received from first calculation module 460, brightness adjustment module 420 can set the light amount of backlight 272 at a light amount obtained by decreasing the stored light amount by the light decrease rate (20%) indicated by light amount change rate 730 corresponding to application program ID 710 that identifies first application program 440, with reference to threshold speed table 700 stored in memory module 430. When a scroll speed other than 0 is received from second calculation module 490, brightness adjustment module 420 can set the light amount of backlight 272 at a light amount obtained by decreasing the stored light amount by the light decrease rate (30%) indicated by light amount change rate 730 corresponding to application program ID 710 that identifies second application program 470, with reference to threshold speed table 700 stored in memory module 430.

When setting the light amount of backlight 272 at the light amount obtained by decreasing the stored light amount by the light decrease rate indicated by light amount change rate 730 corresponding to the relevant application program, brightness adjustment module 420 can wait for a next frame (step S815).

In the next frame, first calculation module 460 or second calculation module 490 can newly calculate the scroll speed (step S820) for transmission to brightness adjustment module 420. Brightness adjustment module 420 can check whether or not the scroll speed is 0 (step S825).

When the scroll speed is not 0 in the operation of step S825 (No in step S825), brightness adjustment module 420 can check whether or not the scroll speed is more than or equal to the threshold speed corresponding to the relevant application program, with reference to threshold speed table 700 stored in memory module 430 (step S830).

In the operation of step S830, when the scroll speed is more than or equal to the threshold speed corresponding to the relevant application program (Yes in step S830), brightness adjustment module 420 returns to the operation of step S810, and repeats the operations of and after step S810.

In the operation of step S830, when the scroll speed is not more than or equal to the threshold speed corresponding to the relevant application program (No in step S830), brightness adjustment module 420 can set the light amount of backlight 272 at a light amount stored finally (step S835).

When setting the light amount of backlight 272 at a light amount stored finally, brightness adjustment module 420 returns to the operation of step S815, and repeats the operations of and after step S815.

In the operation of step S800, when the calculated scroll speed is not more than or equal to the threshold speed corresponding to the relevant application program (No in step S800), brightness adjustment module 420 can wait for a next frame (step S840).

In the next frame, first calculation module 460 or second calculation module 490 can newly calculate the scroll speed (step S845) for transmission to brightness adjustment module 420. Brightness adjustment module 420 returns to the operation of step S800, and repeats the operations of and after step S800.

In the operation of step S825, when the scroll speed is 0 (No in step S825), brightness adjustment module 420 can set the light amount of backlight 272 at a light amount stored finally (step S850). Portable terminal 100 can terminate the scroll processing.

<First Variation>

<Outline>

A portable terminal of a first variation obtained by modifying part of portable terminal 100 according to an embodiment will be described below as an example of the portable terminal according to the present disclosure.

Although the portable terminal of the first variation has a hardware configuration similar to the configuration of portable terminal 100 according to an embodiment, part of software to be executed and part of data to be stored have been modified from portable terminal 100 according to an embodiment.

Portable terminal 100 according to an embodiment is an example of a configuration in which a threshold speed can be stored for each application program, touch panel 110 can be displayed at a first brightness when the scroll speed of a scroll area is less than a threshold speed, and touch panel 110 can be displayed at a second brightness darker than the first brightness when the scroll speed is more than or equal to the threshold speed.

On the other hand, the portable terminal of the first variation is an example of a configuration in which a first threshold speed and a second threshold speed can be stored for each application program, touch panel 110 can be displayed at the first brightness when the scroll speed of a scroll area is less than the first threshold speed, touch panel 110 can be displayed at the second brightness darker than the first brightness when the scroll speed is more than or equal to the first threshold speed and less than the second threshold speed, and the touch panel can be displayed at a third brightness darker than the second brightness when the scroll speed is more than or equal to the second threshold speed.

The portable terminal of the first variation will be described below focusing on differences from portable terminal 100 according to the first embodiment.

<Configuration>

In the portable terminal of the first variation, brightness adjustment module 420 (see FIG. 4) according to the first embodiment has been changed to a brightness adjustment module of the first variation and memory module 430 according to the first embodiment has been changed to a memory module of the first variation.

The memory module of the first variation has a function that can store a threshold speed table 900 of the first variation.

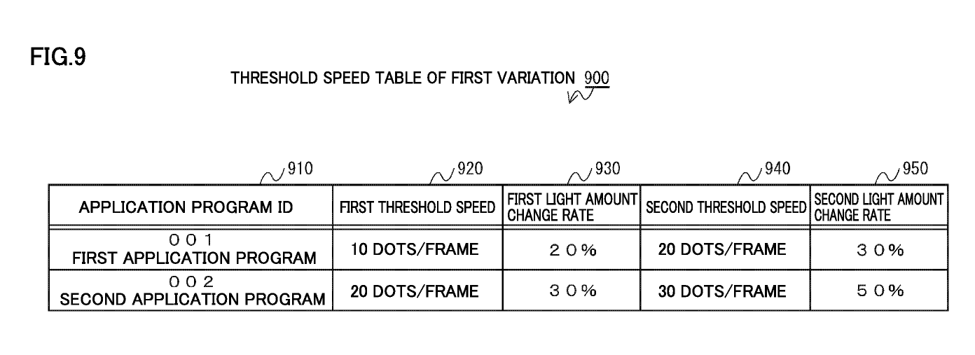

FIG. 9 is threshold speed table 900 of the first variation stored in the memory module of the first variation.

As shown in the drawing, an application program ID 910, a first threshold speed 920, a first light amount change rate 930, a second threshold speed 940, and a second light amount change rate 950 associated with one another constitute threshold speed table 900 of the first variation.

Application program ID 910 is an identifier for identifying an application program having a function of scrolling an image, similarly to application program ID 710 (see FIG. 7) according to the first embodiment.

Assuming that at least part of an image displayed on touch panel 110 is scrolled in a situation where an application program identified by corresponding application program ID 910 is executed by CPU 200, and assuming that the light amount of backlight 272 is changed between when the scroll speed is a first speed and when the scroll speed is a second speed faster than the first speed, threshold speed 920 is a scroll speed for distinguishing between the first speed and the second speed.

Assuming that at least part of an image displayed on touch panel 110 is scrolled in a situation where an application program identified by corresponding application program ID 910 is executed by CPU 200, and assuming that the light amount of backlight 272 is changed between when the scroll speed of that image is a first speed and when the scroll speed is a second speed faster than the first speed, first light amount change rate 930 is a light decrease rate of the light amount of backlight 272 when the scroll speed is the second speed relative to the light amount of backlight 272 when the scroll speed is the first speed.

Assuming that at least part of an image displayed on touch panel 110 is scrolled in a situation where an application program identified by corresponding application program ID 910 is executed by CPU 200, and assuming that the light amount of backlight 272 is changed between when the scroll speed is the second speed and when the scroll speed is a third speed faster than the second speed, second threshold speed 940 is a scroll speed for distinguishing between the second speed and the third speed.

Assuming that at least part of an image displayed on touch panel 110 is scrolled in a situation where an application program identified by corresponding application program ID 910 is executed by CPU 200, and assuming that the light amount of backlight 272 is changed between when the scroll speed of that image is a first speed and when the scroll speed is the third speed faster than the second speed, second light amount change rate 950 is a light decrease rate of the light amount of backlight 272 when the scroll speed is the third speed relative to the light amount of backlight 272 when the scroll speed is the second speed.

The brightness adjustment module of the first variation has twelve functions as described below.

A first determining function is a function that, when a scroll speed is received from first calculation module 460 in the case where CPU 200 executes first application program 440, can determine whether or not that scroll speed is more than or equal to first threshold speed 920 corresponding to application program ID 910 that identifies first application program 440, with reference to threshold speed table 900 of the first variation stored in the memory module of the first variation (this determination will hereinafter be referred to as a “first determination”).

A second determining function is a function that, when a scroll speed is received from first calculation module 460 in the case where CPU 200 executes first application program 440, can determine whether or not that scroll speed is more than or equal to second threshold speed 940 corresponding to application program ID 910 that identifies first application program 440 with reference to threshold speed table 900 of the first variation stored in the memory module of the first variation (this determination will hereinafter be referred to as a “second determination”).

A first light decreasing function is a function that, in the case where the first determination made by CPU 200 changes from the negative determination to the affirmative determination, (1) can store the light amount of backlight 272 at the time of change from the negative determination to the affirmative determination, and (2) if the second determination made by CPU 200 does not change from the negative determination to the affirmative determination, can change the light amount of backlight 272 to a light amount obtained by decreasing the stored light amount by the light decrease rate indicated by first light amount change rate 930 corresponding to application program ID 910 that identifies first application program 440, with reference to threshold speed table 900 of the first variation stored in the memory module of the first variation.

A second light decreasing function is a function that, in the case where the second determination made by CPU 200 changes from the negative determination to the affirmative determination, can change the light amount of backlight 272 to a light amount obtained by decreasing a light amount stored finally by the light decrease rate indicated by second light amount change rate 950 corresponding to application program ID 910 that identifies first application program 440, with reference to threshold speed table 900 of the first variation stored in the memory module of the first variation.

A first brightening function is a function that, in the case where the first determination made by CPU 200 changes from the affirmative determination to the negative determination, can change the light amount of backlight 272 to a light amount stored finally. A second brightening function is a function that, in the case where the second determination made by CPU 200 changes from the affirmative determination to the negative determination and when the first determination made by CPU 200 does not change from the affirmative determination to the negative determination, can change the light amount of backlight 272 to a light amount obtained by decreasing a light amount stored finally by the light decrease rate indicated by first light amount change rate 930 corresponding to application program ID 910 that identifies first application program 440, with reference to threshold speed table 900 of the first variation stored in the memory module of the first variation.

A third determining function is a function that, when a scroll speed is received from first calculation module 460 in the case where CPU 200 is executing second application program 470, can determine whether or not that scroll speed is more than or equal to first threshold speed 920 corresponding to application program ID 910 that identifies second application program 470, with reference to threshold speed table 900 of the first variation stored in the memory module of the first variation (this determination will hereinafter be referred to as a “third determination”).

A fourth determining function is a function that, when a scroll speed is received from first calculation module 460 in the case where CPU 200 is executing second application program 470, can determine whether or not that scroll speed is more than or equal to second threshold speed 940 corresponding to application program ID 910 that identifies second application program 470, with reference to threshold speed table 900 of the first variation stored in the memory module of the first variation (this determination will hereinafter be referred to as a “fourth determination”).

A third light decreasing function is a function that, in the case where the third determination made by CPU 200 changes from the negative determination to the affirmative determination, (1) can store the light amount of backlight 272 at the time of change from the negative determination to the affirmative determination, and (2) if the fourth determination made by CPU 200 does not change from the negative determination to the affirmative determination, can change the light amount of backlight 272 to a light amount obtained by decreasing the stored light amount by the light decrease rate indicated by second light amount change rate 950 corresponding to application program ID 910 that identifies second application program 470, with reference to threshold speed table 900 of the first variation stored in the memory module of the first variation.

A fourth light decreasing function is a function that, in the case where the fourth determination made by CPU 200 changes from the negative determination to the affirmative determination, can change the light amount of backlight 272 to a light amount obtained by decreasing a light amount stored finally by the light decrease rate indicated by second light amount change rate 950 corresponding to application program ID 910 that identifies second application program 470, with reference to threshold speed table 900 of the first variation stored in the memory module of the first variation.

A third brightening function is a function that, in the case where the third determination made by CPU 200 changes from the affirmative determination to the negative determination, can change the light amount of backlight 272 to a light amount stored finally.

A fourth brightening function is a function that, in the case where the fourth determination made by CPU 200 changes from the affirmative determination to the negative determination and when the third determination made by CPU 200 does not change from the affirmative determination to the negative determination, can change the light amount of backlight 272 to a light amount obtained by decreasing a light amount stored finally by the light decrease rate indicated by first light amount change rate 930 corresponding to application program ID 910 that identifies second application program 470, with reference to threshold speed table 900 of the first variation stored in the memory module of the first variation.

Operations performed by the portable terminal of the first variation having the above-described configuration will be described below with reference to the drawings.

<Operation>

Scroll processing of the first variation which is a characteristic operation among the operations performed by the portable terminal of the first variation will be described.

<Scroll Processing of First Variation>

Scroll processing of the first variation is obtained by a modification to change part of the scroll processing according to the first embodiment (see FIG. 8). The scroll processing of the first variation is processing that, in the case where at least a part of an image displayed on touch panel 110 is being scrolled, (1) can decrease the light amount of backlight 272 to a first light amount when the scroll speed of the scroll area becomes more than or equal to a first threshold speed and less than a second threshold speed, (2) can further decrease the light amount of backlight 272 to a second light amount smaller than the first light amount when the scroll speed becomes more than or equal to the second threshold speed, (3) can return the light amount of backlight 272 to the first light amount when the scroll speed of the scroll area becomes more than or equal to the first threshold speed and less than the second threshold speed again, and (4) can return the light amount of backlight 272 to the original light amount when the scroll speed becomes less than the first threshold speed again.

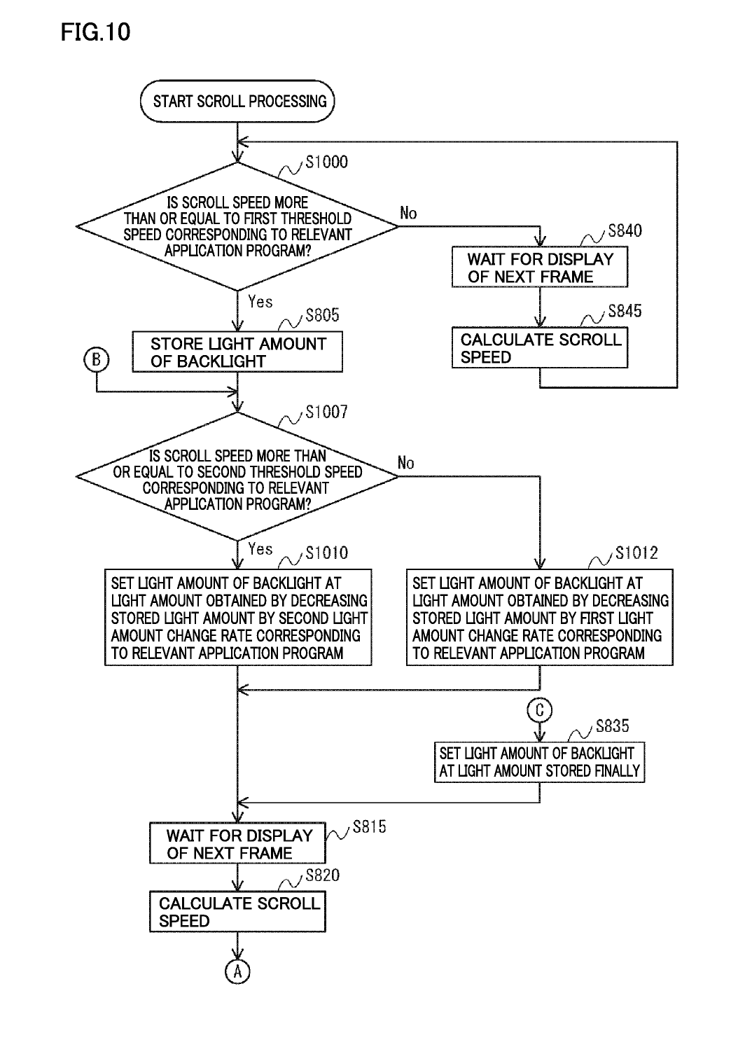

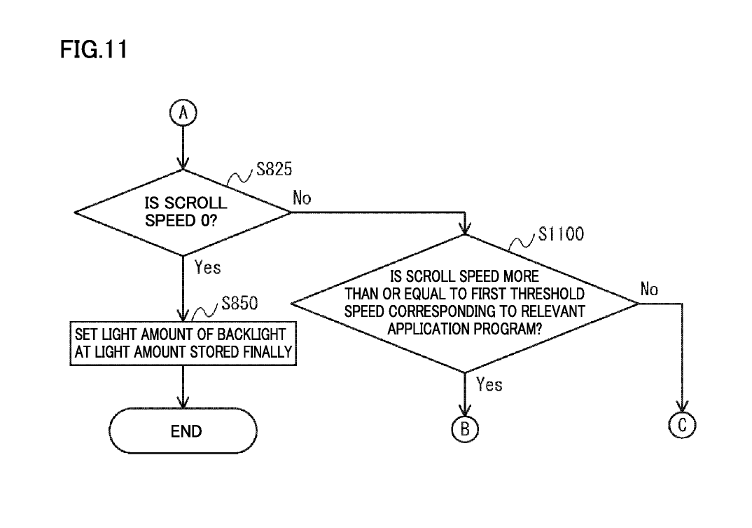

FIGS. 10 and 11 are flowcharts of scroll processing of the first variation.

As shown in FIGS. 10 and 11, the scroll processing of the first variation has been modified by deleting the operation of step S800, the operation of step S810 and the operation of step S830 from the scroll processing according to the first embodiment, and adding an operation of step S1000, operations of steps S1007 to S1012, and an operation of step S1100.

Description will be focused on the operation of step S1000, the operations of steps S1007 to S1012, and the operation of step S1100.

The scroll processing of the first variation can be started when first calculation module 460 has calculated a scroll speed other than 0 or when second calculation module 490 has calculated a scroll speed other than 0, similarly to the scroll processing according to the first embodiment.

When the scroll processing of the first variation is started, the brightness adjustment module of the first variation can check whether or not the calculated scroll speed is more than or equal to first threshold speed 920 corresponding to a relevant application program, with reference to threshold speed table 900 of the first variation stored in the memory module of the first variation (step S1000).

In the operation of step S1000, in the case where the calculated scroll speed is more than or equal to first threshold speed 920 corresponding to the relevant application program (Yes in step S1000), the portable terminal of the first variation proceeds into the operation of step S805.

In the operation of step S1000, in the case where the calculated scroll speed is not more than or equal to first threshold speed 920 corresponding to the relevant application program (No in step S1000), the portable terminal of the first variation proceeds into the operation of step S840.

When the operation of step S805 is terminated, the brightness adjustment module of the first variation can check whether or not the calculated scroll speed is more than or equal to second threshold speed 940 corresponding to the relevant application program, with reference to threshold speed table 900 of the first variation stored in the memory module of the first variation (step S1007).

In the operation of step S1007, in the case where the calculated scroll speed is more than or equal to second threshold speed 940 corresponding to the relevant application program (Yes in step S1007), the brightness adjustment module of the first variation can set the light amount of backlight 272 at a light amount obtained by decreasing the stored light amount by the light decrease rate indicated by second light amount change rate 950 corresponding to the relevant application program, with reference to threshold speed table 900 of the first variation stored in the memory module of the first variation (step S1010).

In the operation of step S1007, when the calculated scroll speed is not more than or equal to second threshold speed 940 corresponding to the relevant application program (No in step S1007), the brightness adjustment module of the first variation can set the light amount of backlight 272 at a light amount obtained by decreasing the stored light amount by the light decrease rate indicated by first light amount change rate 930 corresponding to the relevant application program, with reference to threshold speed table 900 of the first variation stored in the memory module of the first variation (step S1012).

When the operation of step S1010 is terminated, or when the operation of step S1012 is terminated, the portable terminal of the first variation proceeds into the operation of step S815.

In the operation of step S825, when the scroll speed is not 0 (No in step S825), the brightness adjustment module of the first variation can check whether or not the scroll speed is more than or equal to first threshold speed 920 corresponding to the relevant application program, with reference to threshold speed table 900 of the first variation stored in the memory module of the first variation (step S1100).

In the operation of step S1100, when the scroll speed is more than or equal to first threshold speed 920 corresponding to the relevant application program (Yes in step S1100), the portable terminal of the first variation proceeds into the operation of step S1007.

In the operation of step S1100, when the scroll speed is not more than or equal to first threshold speed 920 corresponding to the relevant application program (No in step S1100), the portable terminal of the first variation proceeds into the operation of step S835.

<Second Variation>

<Outline>

A portable terminal of a second variation obtained by modifying part of portable terminal 100 according to an embodiment will be described below as an example of the portable terminal according to the present disclosure.

The portable terminal of the second variation has a hardware configuration obtained by modifying portable terminal 100 according to an embodiment by changing touch panel 110 to a touch panel of the second variation, and by changing part of software to be executed and part of data to be stored have been modified from portable terminal 100 according to an embodiment.

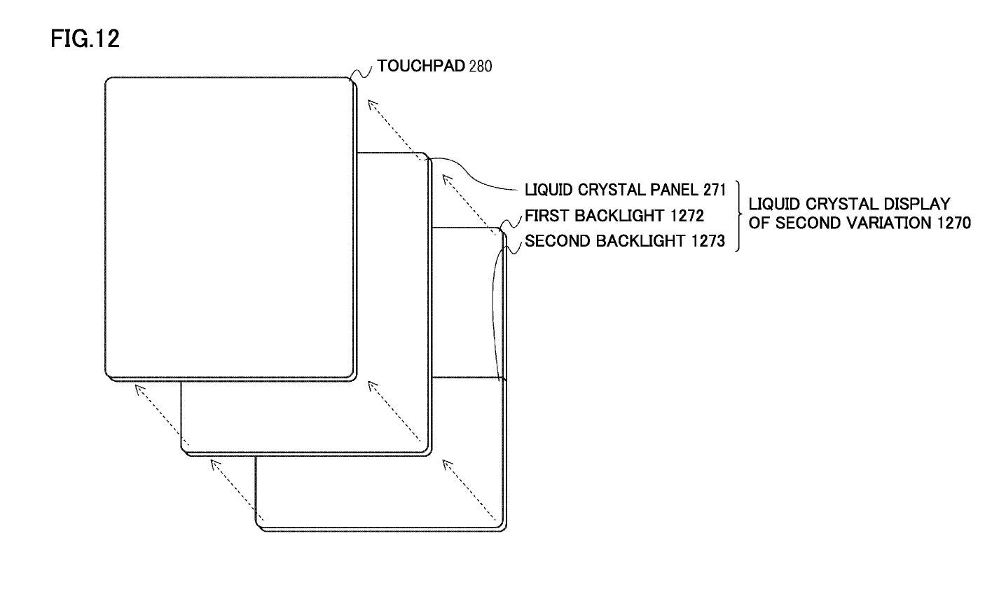

FIG. 12 is an exploded perspective view of a touch panel of the second variation.

As shown in the drawing, the touch panel of the second variation is obtained by modifying touch panel 110 according to an embodiment such that backlight 272 is divided into a first backlight 1272 and a second backlight 1273. Accordingly, the light amount of first backlight 1272 and the light amount of second backlight 1273 may be controlled independently of each other.

Portable terminal 100 according to an embodiment is an example of a configuration of changing the light amount of backlight 272 in accordance with the scroll speed of a scroll area, irrespective of the position and size of the scroll area.

On the other hand, the portable terminal of the second variation is an example of a configuration in which, when a scroll area is included in an area corresponding to first backlight 1272, the light amount of first backlight 1272 can be changed in accordance with the scroll speed of the scroll area, and when the scroll area is included in an area corresponding to second backlight 1273, the light amount of second backlight 1273 can be changed in accordance with the scroll speed of the scroll area.

The portable terminal of the second variation will be described focusing on differences from portable terminal 100 according to the first embodiment.

<Configuration>

The portable terminal of the second variation is obtained by modifying portable terminal 100 according to an embodiment by changing brightness adjustment module 420 (see FIG. 4) to a brightness adjustment module of the second variation in terms of functional configuration, in addition to the modification of the touch panel in the above-described hardware configuration.

The brightness adjustment module of the second variation has the following nine functions in addition to the first determining function and the second determining function of brightness adjustment module 420 according to the first embodiment.

An area determining function is a function that, when a scroll speed is received from first calculation module 460, can determine whether a corresponding scroll area is included (1) only in an area corresponding to first backlight 1272, (2) only in an area corresponding to second backlight 1273, or (3) in both of the area corresponding to first backlight 1272 and the area corresponding to second backlight 1273.

A first-area first-light-decreasing function is a function that, when the first determination made by CPU 200 changes from the negative determination to the affirmative determination in the case where the area determining function of CPU 200 determines that a corresponding scroll area is included (1) only in the area corresponding to first backlight 1272 or (3) in both of the area corresponding to first backlight 1272 and the area corresponding to second backlight 1273, (1) can store the light amount of first backlight 1272 at the time when the negative determination is changed to the affirmative determination, and (2) with reference to threshold speed table 700 stored in memory module 430, can change the light amount of first backlight 1272 to a light amount obtained by decreasing the stored light amount by the light decrease rate indicated by light amount change rate 730 corresponding to application program ID 710 that identifies first application program 440.

A first-area first-brightening function is a function that, when the first determination made by CPU 200 changes from the affirmative determination to the negative determination in the case where the area determining function of CPU 200 determines that a corresponding scroll area is included (1) only in the area corresponding to first backlight 1272 or (3) in both of the area corresponding to first backlight 1272 and the area corresponding to second backlight 1273, can change the light amount of first backlight 1272 to a light amount stored finally.

A second-area first-light-decreasing function is a function that, when the first determination made by CPU 200 changes from the negative determination to the affirmative determination in the case where the area determining function of CPU 200 determines that a corresponding scroll area is included (2) only in an area corresponding to second backlight 1273 or (3) in both of the area corresponding to first backlight 1272 and the area corresponding to second backlight 1273, (1) can store the light amount of second backlight 1273 at the time when the negative determination is changed to the affirmative determination, and (2) with reference to threshold speed table 700 stored in memory module 430, can change the light amount of second backlight 1273 to a light amount obtained by decreasing the stored light amount by the light decrease rate indicated by light amount change rate 730 corresponding to application program ID 710 that identifies first application program 440.

A second-area first-brightening function is a function that, when the first determination made by CPU 200 changes from the affirmative determination to the negative determination in the case where the area determining function of CPU 200 determines that a corresponding scroll area is included (2) only in an area corresponding to second backlight 1273 or (3) in both of the area corresponding to first backlight 1272 and the area corresponding to second backlight 1273, can change the light amount of first backlight 1272 to a light amount stored finally.

A first-area second-light-decreasing function is a function that, when the second determination made by CPU 200 changes from the negative determination to the affirmative determination in the case where the area determining function of CPU 200 determines that a corresponding scroll area is included (1) only in the area corresponding to first backlight 1272 or (3) in both of the area corresponding to first backlight 1272 and the area corresponding to second backlight 1273, (1) can store the light amount of first backlight 1272 at the time when the negative determination is changed to the affirmative determination, and (2) with reference to threshold speed table 700 stored in memory module 430, can change the light amount of first backlight 1272 to a light amount obtained by decreasing the stored light amount by the light decrease rate indicated by light amount change rate 730 corresponding to application program ID 710 that identifies second application program 470.

A first-area second-brightening function is a function that, when the second determination made by CPU 200 changes from the affirmative determination to the negative determination in the case where the area determining function of CPU 200 determines that a corresponding scroll area is included (1) only in the area corresponding to first backlight 1272 or (3) in both of the area corresponding to first backlight 1272 and the area corresponding to second backlight 1273, can change the light amount of first backlight 1272 to a light amount stored finally.

A second-area second-light-decreasing function is a function that, when the second determination made by CPU 200 changes from the negative determination to the affirmative determination in the case where the area determining function of CPU 200 determines that a corresponding scroll area is included (2) only in an area corresponding to second backlight 1273 or (3) in both of the area corresponding to first backlight 1272 and the area corresponding to second backlight 1273, (1) can store the light amount of second backlight 1273 at the time when the negative determination is changed to the affirmative determination, and (2) with reference to threshold speed table 700 stored in memory module 430, can change the light amount of second backlight 1273 to a light amount obtained by decreasing the stored light amount by the light decrease rate indicated by light amount change rate 730 corresponding to application program ID 710 that identifies second application program 470.

A second-area second-brightening function is a function that, when the second determination made by CPU 200 changes from the affirmative determination to the negative determination in the case where the area determining function of CPU 200 determines that a corresponding scroll area is included (2) only in an area corresponding to second backlight 1273 or (3) in both of the area corresponding to first backlight 1272 and the area corresponding to second backlight 1273, can change the light amount of second backlight 1273 to a light amount stored finally.

Operations performed by the portable terminal of the second variation of the above-described configuration will be described below with reference to the drawings.

<Operation>

Scroll processing of the second variation which is a characteristic operation among the operations performed by the portable terminal of the second variation will be described.

<Scroll Processing of Second Variation>

The scroll processing of the second variation is processing obtained by modifying the scroll processing according to the first embodiment (see FIG. 8) such that the processing is partially changed, and is processing that (1) in the case where the scroll area is included in the area corresponding to first backlight 1272, (a) when the scroll speed of the scroll area becomes more than or equal to a threshold speed, can decrease the light amount of first backlight 1272, (b) when the scroll speed of the scroll area becomes less than the threshold speed again, can return the light amount of first backlight 1272 to the original light amount, (2) in the case where the scroll area is included in the area corresponding to second backlight 1273, (a) when the scroll speed of the scroll area becomes more than or equal to the threshold speed, can decrease the light amount of second backlight 1273, (b) when the scroll speed of the scroll area becomes less than the threshold speed again, can return the light amount of second backlight 1273 to the original light amount.

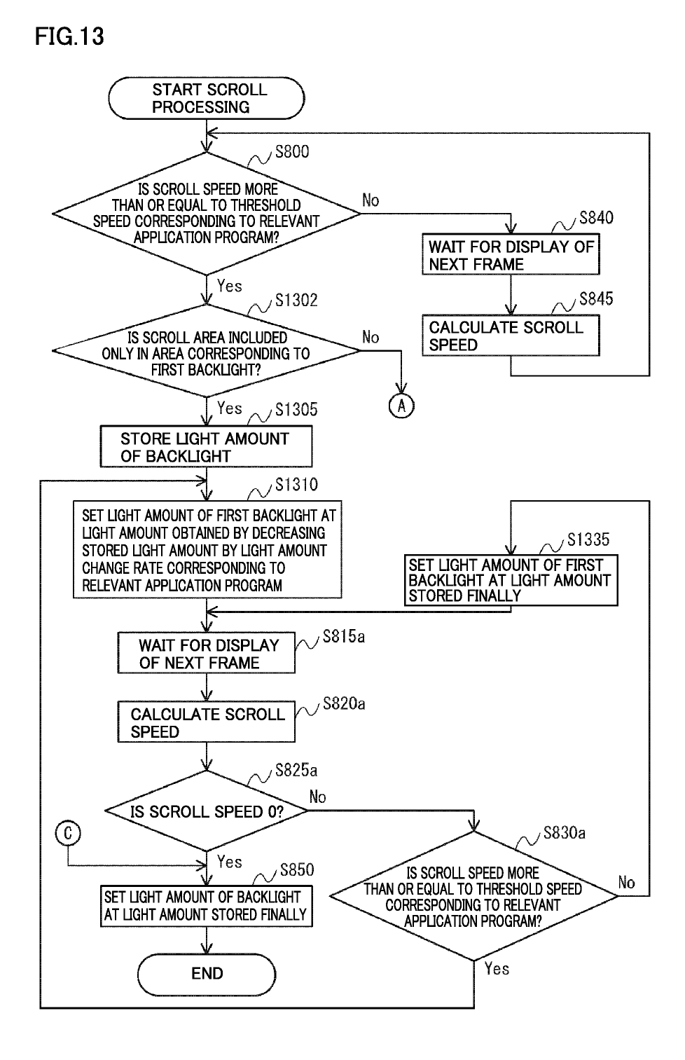

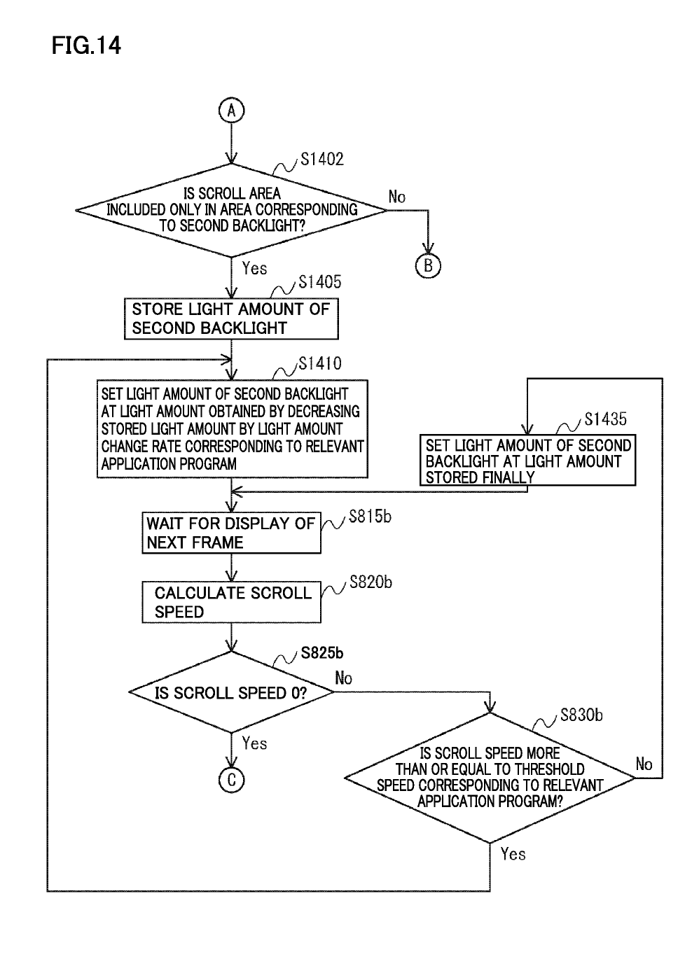

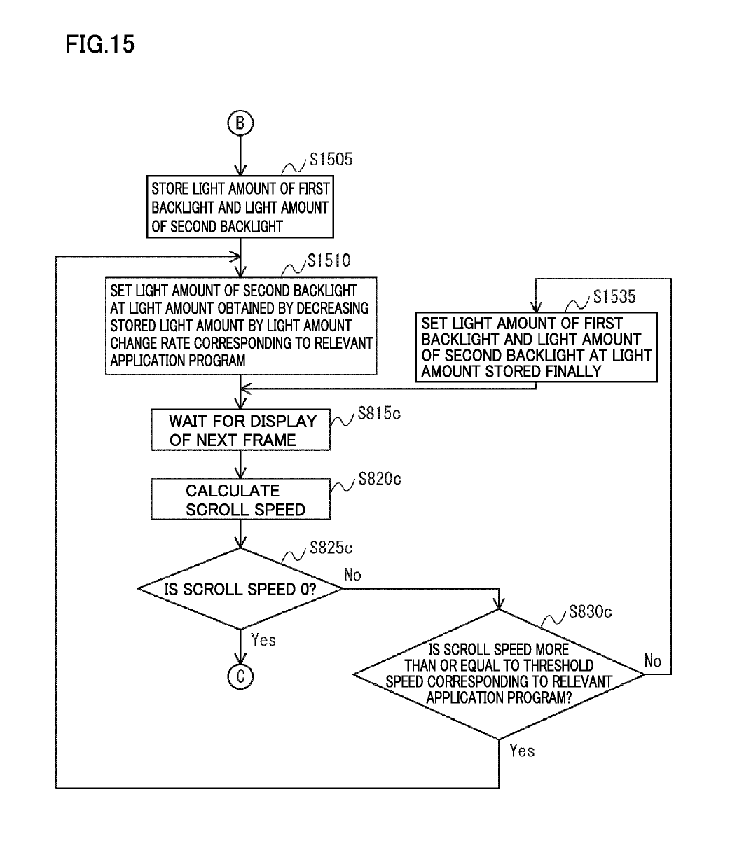

FIGS. 13 to 15 are flowcharts of the scroll processing of the second variation.

As shown in FIGS. 13 to 15, the scroll processing of the second variation is obtained by modifying the scroll processing according to the first embodiment by deleting the operation of step S805, the operation of step S810 and the operation of step S835, and adding operations of steps S1302 to S1310, an operation of S1335, operations of steps S1402 to S1410, an operation of step S1435, operations of S1505 to S1510, and an operation of step S1535.

It should be noted that operations of steps S815a, S815b and S815c are equivalent to the operation of step S815, operations of steps S820a, S820b and S820c are equivalent to the operation of step S820, operations of steps S825a, S825b and S825c are equivalent to the operation of step S825, and operations of steps S830a, S830b and S830c are equivalent to the operation of step S830.

Description will be focused on the operations of steps S1302 to S1310, the operation of step S1335, the operations of steps S1402 to S1410, the operation of step S1435, the operations of S1505 to S1510, and the operation of step S1535.

The scroll processing of the second variation can be started when first calculation module 460 has calculated a scroll speed other than 0 or when second calculation module 490 has calculated a scroll speed other than 0, similarly to the scroll processing according to the first embodiment.

When the scroll processing of the second variation is started, the portable terminal of the second variation can perform the operation of step S800.

In the operation of step S800, in the case where the calculated scroll speed is more than or equal to the threshold speed corresponding to a relevant application program (Yes in step S800), the brightness adjustment module of the second variation can check whether or not the corresponding scroll area is included only in the area corresponding to first backlight 1272 (step S1302).

In the operation of step S1302, when the corresponding scroll area is included only in the area corresponding to first backlight 1272 (Yes in step S1302), the brightness adjustment module of the second variation can store the light amount of first backlight 1272 at present (step S1305).

With reference to threshold speed table 700 stored in the memory module 433, the brightness adjustment module of the second variation can set the light amount of first backlight 1272 at a light amount obtained by decreasing the stored light amount by the light decrease rate indicated by light amount change rate 730 corresponding to the relevant application program (step S1310).

After the operation of step S1310 is terminated, the portable terminal of the second variation proceeds into the operation of step S815a.

In the operation of step S830a, when the scroll speed is more than or equal to the threshold speed corresponding to the relevant application program (Yes in step S830a), the brightness adjustment module of the second variation proceeds into the operation of step S1310.

In the operation of step S830a, when the scroll speed is not more than or equal to the threshold speed corresponding to the relevant application program (No in step S830a), the brightness adjustment module of the second variation can set the light amount of first backlight 1272 at a light amount stored finally (step S1335).

In the operation of step S1302, when the corresponding scroll area is not included only in the area corresponding to first backlight 1272 (No in step S1302), the brightness adjustment module of the second variation can check whether or not the corresponding scroll area is included only in the area corresponding to second backlight 1273 (step S1402).

In the operation of step S1402, when the corresponding scroll area is included only in the area corresponding to second backlight 1273 (Yes in step S1402), the brightness adjustment module of the second variation can store the light amount of second backlight 1273 at present (step S1405). With reference to threshold speed table 700 stored in memory module 430, the brightness adjustment module of the second variation can set the light amount of second backlight 1273 at a light amount obtained by decreasing the stored light amount by the light decrease rate indicated by light amount change rate 730 corresponding to the relevant application program on (step S1410).

After the operation of step S1410 is terminated, the portable terminal of the second variation proceeds into the operation of step S815b.

In the operation of step S830b, when the scroll speed is more than or equal to the threshold speed corresponding to the relevant application program (Yes in step S830b), the brightness adjustment module of the second variation proceeds into the operation of step S1410.

In the operation of step S830b, when the scroll speed is not more than or equal to the threshold speed corresponding to the relevant application program (No in step S830b), the brightness adjustment module of the second variation can set the light amount of second backlight 1273 at a light amount stored finally (step S1435).

In the operation of step S1402, when the corresponding scroll area is not included only in the area corresponding to second backlight 1273 (No in step S1402), the brightness adjustment module of the second variation can store the light amount of first backlight 1272 and the light amount of second backlight 1273 at present (step S1505). With reference to threshold speed table 700 stored in memory module 430, the brightness adjustment module of the second variation can set the light amount of first backlight 1272 and the light amount of second backlight 1273 at a light amount obtained by decreasing the stored light amount by the light decrease rate indicated by light amount change rate 730 corresponding to the relevant application program (step S1510).

After the operation of step S1510 is terminated, the portable terminal of the second variation proceeds into the operation of step S815c.

In the operation of step S830c, when the scroll speed is more than or equal to the threshold speed corresponding to the relevant application program (Yes in step S830c), the brightness adjustment module of the second variation proceeds into the operation of step S1510.

In the operation of step S830c, when the scroll speed is not more than or equal to the threshold speed corresponding to the relevant application program (No in step S830c), the brightness adjustment module of the second variation can set the light amount of first backlight 1272 and the light amount of second backlight 1273 at a light amount stored finally (step S1435).

In each embodiment as described above, the brightness of an image can be adjusted such that the brightness of an image displayed on the display when scrolling at a second speed is darker than the brightness of an image displayed on the display when scrolling at a first speed. Accordingly, in this portable terminal, when an image being displayed at a usual image brightness is scrolled at the second speed, the brightness of that image is made darker than the usual image brightness, and reduction in power consumption thereof can be achieved.

<Supplement>

As described above, portable terminal 100, the portable terminal of the first variation and the portable terminal of the second variation have been described by way of example in an embodiment, the first variation and the second variation as an embodiment of the portable terminal according to the present disclosure, respectively. It is needless to say that they may be modified as will be described below, and the present disclosure is not limited to the portable terminals as described in the embodiment, the first variation and the second variation.

(1) In an embodiment, portable terminal 100 has an exemplary configuration having a liquid crystal display in which the brightness of an image displayed on a display may be adjusted by adjusting the light amount of a backlight. However, provided that the display of portable terminal 100 is a display in which the brightness of an image displayed may be adjusted, it does not necessarily need to be a liquid crystal display. As an example, a conceivable exemplary configuration includes a display formed of self-luminous elements (e.g., an electro-luminescence display). With such a display, the brightness of an image displayed may be adjusted by adjusting the luminance of each light emitting element, for example.

(2) In an embodiment, portable terminal 100 has an exemplary configuration which is a so-called smartphone-type portable communication terminal. However, provided that portable terminal 100 has the function to perform processing equivalent to scroll processing, it does not necessarily need to be a so-called smartphone-type portable communication terminal. As an example, conceivable examples include a tablet personal computer, a PDA (Personal Digital Assistant), a folding portable communication terminal, and the like having the function to perform processing equivalent to scroll processing.

(3) In an embodiment, portable terminal 100 has an exemplary configuration in which two application programs, namely, first application program 440 and second application program 470 are subject to scroll processing. However, with a configuration including programs to be subject to scroll processing, the number of the application programs to be subject to scroll processing is not necessarily limited to two. The configuration may include four application programs to be subject to scroll processing, for example.

(4) The embodiments and variations described above may be combined, respectively.

(5) A configuration of a portable terminal according to an embodiment of the present disclosure and its variations as well as their respective effects will be described below.

(a) The portable terminal according to an embodiment of the present disclosure includes a display, a display processing module configured to perform display processing of causing the display to display an image such that an image in a scroll target area which is at least a portion of an image display area on the display is scrolled, a calculation module configured to perform calculation processing of calculating a scroll speed of the image in the scroll target area, and a brightness adjustment module configured to perform an adjustment to a brightness of an image displayed on the display such that, in the case where the scroll speed calculated by the calculation module is a second speed faster than a first speed, the brightness of an image displayed on the display in the case of the second speed becomes darker than an image displayed on the display in the case of the first speed.

A user using a portable terminal may scroll an image displayed on the display such that a display target to be displayed is displayed on the display. When it is predicted that a relatively long time will be necessary until a display target to be displayed appears on the display during a period of scrolling an image, the user is likely to scroll the image relatively quickly while hardly gazing at the image being scrolled, and when it is predicted that a relatively long time will not be necessary until a display target to be displayed appears on the display, the user is likely to scroll the image relatively slowly while relatively fixedly gazing at the image being scrolled.

Therefore, it can be the that relatively little discomfort is given to the user if the brightness of an image during a period in which the image is being scrolled relatively quickly and in which a user is less likely to gaze at the image being scrolled is made darker than the brightness of an image during a period in which the image is being scrolled relatively slowly and in which a user is likely to gaze at the image being scrolled.

With the portable terminal according to the present embodiment having the above-described configuration, the brightness of an image is adjusted such that an image displayed on the display in the case of scrolling at the second speed becomes darker than the brightness of an image displayed on the display in the case of scrolling at the first speed. Accordingly, in this portable terminal, when an image being displayed at a usual image brightness is scrolled at the second speed, the brightness of that image is made darker than the usual image brightness, which can achieve reduction of power consumption thereof.

(b) The portable terminal includes a reception module configured to receive a scroll operation for scrolling the image in the scroll target area. When the scroll operation is received by the reception module, the display processing module may perform the display processing such that the image in the scroll target area is scrolled in accordance with the scroll operation.

Accordingly, the image in the scroll target area can be scrolled in accordance with a scroll operation made by a user using the portable terminal.

(c) The portable terminal includes a memory module configured to store a threshold speed for distinguishing between the first speed and the second speed. The brightness adjustment module may perform the adjustment such that, with reference to the threshold speed stored in the memory module, the image displayed on the display is displayed at a first brightness when the scroll speed calculated by the calculation module is less than the threshold speed, and the image displayed on the display is displayed at a second brightness darker than the first brightness when the scroll speed calculated by the calculation module is more than or equal to the threshold speed.

Accordingly, the brightness of an image displayed on the display can be changed stepwise.

(d) The display processing module may be configured to perform the display processing for each of a plurality of application programs executed by a processor, the image displayed on the display being different among the plurality of application programs. The calculation module may perform the calculation processing for each of the plurality of application programs.

Accordingly, the brightness of an image displayed on the display can be adjusted for each application program.

(e) The display processing module includes a first display processing module implemented by the processor executing a first application program and configured to perform, as the display processing, first display processing of causing the display to display a first type image determined by the first application program, and a second display processing module implemented by the processor executing a second application program and configured to perform, as the display processing, second display processing of causing the display to display a second type image determined by the second application program.

The calculation module includes a first calculation module that can be implemented by the processor executing the first application program and performs, as the calculation processing, first calculation processing that can calculate, for the first type image, a first scroll speed of the image in the scroll target area, and a second calculation module that can be implemented by the processor executing the second application program and can perform, as the calculation processing, second calculation processing of calculating, for the second type image, a second scroll speed of the image in the scroll target area. The memory module can store, as the threshold speed, a first threshold speed for distinguishing between the first speed and the second speed in the first type image, and a second threshold speed for distinguishing between the first speed and the second speed in the second type image. The brightness adjustment module can perform the adjustment such that, in the case where the first scroll speed is calculated by the first calculation module, with reference to the first threshold speed stored in the memory module, the image displayed on the display is displayed at the first brightness when the first scroll speed is less than the first threshold speed, and the image displayed on the display is displayed at the second brightness when the first scroll speed is more than or equal to the first threshold speed, and may perform the adjustment such that, in the case where the second scroll speed is calculated by the second calculation module, with reference to the second threshold speed stored in the memory module, the image displayed on the display is displayed at the first brightness when the second scroll speed is less than the second threshold speed, and the image displayed on the display is displayed at the second brightness when the second scroll speed is more than or equal to the second threshold speed.

Accordingly, the threshold speed can be set independently of each other in the first application program and the second application program.

(f) The display includes a liquid crystal panel and a backlight located on a rear surface of the liquid crystal panel. The brightness adjustment module may perform the adjustment by changing a light amount of the backlight.

Accordingly, the brightness of an image displayed on the display can be adjusted by changing the light amount of the backlight.

(g) The display is composed of a plurality of pixels formed of light emitting elements, and the brightness adjustment module may perform the adjustment by changing luminance of the light emitting elements.

Accordingly, the brightness of an image displayed on the display can be adjusted by changing the luminance of the light emitting elements.

(h) The brightness adjustment module may further perform the adjustment by adjusting the brightness of the image displayed on the display such that, in the case where the scroll speed calculated by the calculation module is a third speed faster than the second speed, the image displayed on the display in the case of the third speed becomes darker than the image displayed on the display in the case of the second speed.

Accordingly, stepwise change in brightness of the image displayed on the display can further be incremented by one step.

(i) The brightness adjustment module may perform the adjustment only for an image in an adjustment target area being a partial area of the image display area on the display, the adjustment target area including the scroll target area.

Accordingly, the brightness of an image can be adjusted for a partial area of the image display area on the display.

The present disclosure can be widely applied to portable terminals provided with a display.

Besides, embodiments of the present disclosure can be variously modified as appropriate within the scope of the technical idea set forth in the claims.

Although the present disclosure has been described and illustrated in detail, it is clearly understood that the same is by way of illustration and example only and is not to be taken by way of limitation, the scope of the present disclosure being interpreted by the terms of the appended claims.

1. A portable terminal, comprising:
a display; and
a processor configured to:
cause the display to display an image such that the image in a scroll target area which is at least a portion of an image display area on the display is scrolled,
calculate a scroll speed of the image in the scroll target area, the scroll speed including a first speed and a second speed which is faster than the first speed, and
adjust a brightness of the image displayed on the display such that the brightness is darker when the scroll speed is the second speed than when the scroll speed is the first speed.

2. The portable terminal according to claim 1, further comprising a reception module configured to receive a scroll operation for scrolling the image in the scroll target area, wherein
the processor is configured to, when the scroll operation is received, cause the display to display the image such that the image in the scroll target area is scrolled in accordance with the scroll operation.

3. The portable terminal according to claim 2, further comprising a memory module configured to store a threshold speed for distinguishing between the first speed and the second speed, wherein
the processor is configured to cause the display to display the image such that the image is displayed at a first brightness when the scroll speed is less than the threshold speed, and the image is displayed at a second brightness when the scroll speed is more than or equal to the threshold speed, the second brightness being darker than the first brightness.

4. The portable terminal according to claim 3, wherein
the processor is configured to cause the display to display an image based on each of a plurality of application programs, the image displayed on the display being different among the plurality of application programs, and
calculate the scroll speed of the image based on each of the plurality of application programs.

5. The portable terminal according to claim 4, wherein
the memory module is configured to store, as the threshold speed, a first threshold speed for distinguishing between the first speed and the second speed in a first type image, and a second threshold speed for distinguishing between the first speed and the second speed in a second type image,
the processor is configured to, based on the first application,
cause the display to display the first type image,
calculate a first scroll speed of the first type image in the scroll target area, and
cause the display to display the first type image at the first brightness when the first scroll speed is less than the first threshold speed, and display the first type image at the second brightness when the first scroll speed is more than or equal to the first threshold speed,
the processor is configured to, based on the second application,
cause the display to display the second type image,
calculate a second scroll speed of the second type image in the scroll target area, and
cause the display to display the second type image at the first brightness when the second scroll speed is less than the second threshold speed, and display the second type image at the second brightness when the second scroll speed is more than or equal to the second threshold speed.

6. The portable terminal according to claim 3, wherein
the display includes a liquid crystal panel and a backlight located on a rear surface of the liquid crystal panel, and
the processor is configured to adjust the brightness of the image by changing a light amount of the backlight.

7. The portable terminal according to claim 3, wherein
the display includes a plurality of pixels formed of light emitting elements, and
the processor is configured to adjust the brightness of the image by changing luminance of the light emitting elements.

8. The portable terminal according to claim 1, wherein
the processor is further configured to adjust the brightness of the image displayed on the display such that the brightness of the image when the scroll speed is a third speed faster than the second speed becomes darker than when the scroll speed is the second speed.

9. The portable terminal according to claim 1, wherein
the processor is configured to adjust only brightness of an image in an adjustment target area being a partial area of the image display area on the display, the adjustment target area including the scroll target area.

10. A method for controlling a portable terminal including a display, comprising the steps of:
causing the display to display an image such that the image in a scroll target area which is at least a portion of an image display area on the display is scrolled;
calculating a scroll speed of the image in the scroll target area, the scroll speed including a first speed and a second speed which is faster than the first speed; and
adjusting a brightness of the image displayed on the display such that the brightness is darker when the scroll speed is the second speed than when the scroll speed is the first speed.
